(19) United States
(12) Patent Application Publication
(10) Pub. No.: US 2014/0114728 A1
(43) Pub. Date: Apr. 24, 2014

(54) METHOD AND SYSTEM FOR DATABASE BENCHMARKING

(71) Applicants: Martin Kaufmann, Zurich (CH); Norman May, Karlsruhe (DE); Donald Kossmann, Zurich (CH)

(72) Inventors: Martin Kaufmann, Zurich (CH); Norman May, Karlsruhe (DE); Donald Kossmann, Zurich (CH)

(21) Appl. No.: 13/656,193

(22) Filed: Oct. 19, 2012

(51) Int. Cl. G06Q 10/00

(52) U.S. Cl. 705/7.39

(57) ABSTRACT

A method and system to define a plurality of benchmark component types, each of the benchmark component types being a meta model defining the benchmark component type; generate instances of the plurality of benchmark component types; define parameters associated with the plurality of benchmark component types; and combine one or more of the instances of the plurality of benchmark component types and the defined parameters associated with the benchmark component types being combined.

### FIELD

Some embodiments relate to a benchmark. In particular, some embodiments concern methods and systems for modeling and executing a benchmark.

### BACKGROUND

Benchmarks provide a mechanism for evaluating the performance of a system, device, or service. In some regards, industry accepted benchmarks have been defined to provide a de-facto standard in evaluating and comparing the performance of, for example, different database systems. However, while the definition of the benchmarks may be standardized running these so-called standard benchmarks typically requires a significant effort since a range of tools need to be coordinated to run the actual workloads, modify the workloads parameters according to specific distributions, and to visualize the results. For example, it has been observed that typically a large number of scripts written in different programming languages are applied to implement multiple benchmarks.

The problem of defining and running benchmarks has been recognized by both the research community and commercial vendors, leading to a wide range of tools. Some of the heretofore benchmarking applications provide a framework that focuses primarily on an ad-hoc execution of a particular kind of benchmark. Other benchmarking applications or services rely on a scripting approach that leads to a limited reusability and extendibility of its pre-defined components. Other approaches have limitations such as, for example, being directed to non-relational data and provide limited meta models and execution flexibility.

### BRIEF DESCRIPTION OF THE DRAWINGS

FIG. 1 is an illustrative depiction of an abstract data model of a benchmark definition, according to some embodiments.

FIG. 2 is flow diagram of a process according to some embodiments.

FIG. 3 is a block diagram of a system, in accordance with some embodiments herein.

FIG. 4 is a flow diagram of a process according to some embodiments herein.

FIG. 5 is an illustrative depiction of a measurement result, in accordance with some embodiments herein.

FIG. 6 is an outward view of a graphical user interface layout according to some embodiments.

FIG. 7 is an outward view of a graphical user interface layout according to some embodiments.

FIG. 8 is another view of a graphical user interface layout according to some embodiments.

FIG. 9 is yet another another view of a graphical user interface layout according to some embodiments.

### DETAILED DESCRIPTION

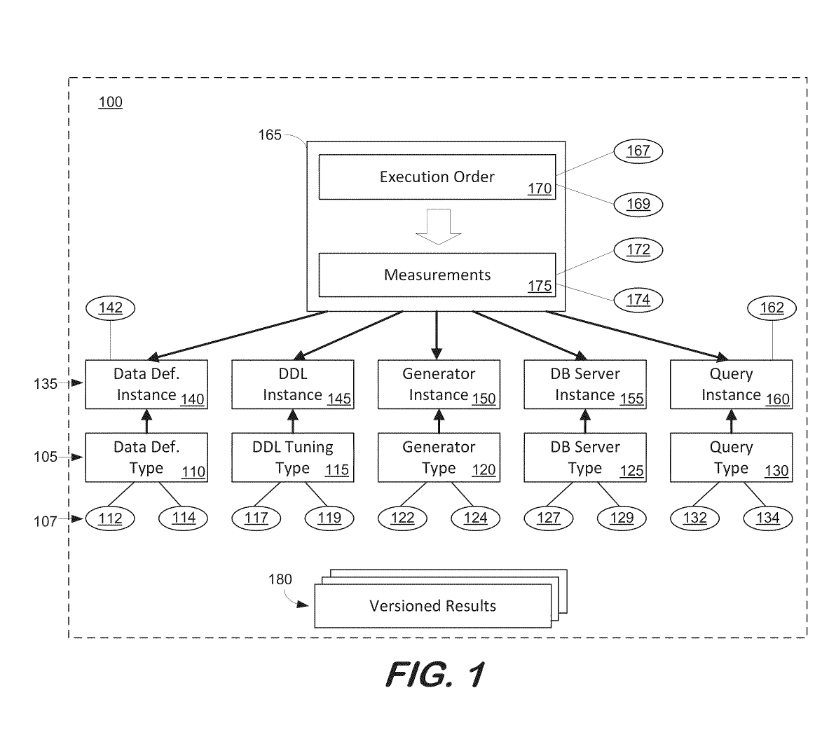

FIG. 1 is an illustrative depiction of a data model 100 of a benchmark definition, according to some embodiments herein. FIG. 1 represents an abstract data model defining a benchmark according to some embodiments. As referred to herein, a benchmark may include one or more applications, programs, execution threads, services, and other operations that are operable to determine performance characteristic(s) of a device, system, service, and different configurations thereof. In some embodiments, a benchmark defined according to abstract data model 100 may be generated and executed to evaluate, for example, a performance of a database instance. In general, a benchmark modeled according to the present disclosure may be implemented as a benchmark service.

In some aspects, a benchmarking service or application in accordance with data model 100 includes a plurality of benchmark component types 105. In some regards, a benchmark component type may also be referred to as an artifact type herein. Each of the plurality of benchmark component types 105 is a meta model that represents concept(s) of the benchmark. Benchmark component types 105 are on a “meta-model” level and they each define or specify a type of component comprising the benchmark of data model 100. In some aspects, benchmark components 105 may be parameterized, stored, and reused. Parameters 107 may be defined and associated with the different plurality of benchmark component types 105 such that characteristics and attributes of the plurality of benchmark component types 105 may be flexibly configured. In some embodiments, the attributes of parameters 107 associated with the plurality of benchmark component types 105 may be specified by a user (e.g., a developer) via a user interface such as, for example, a graphical user interface.

In some embodiments, the plurality of benchmark component types 105 may include one or more of the following types of benchmark components : a data definition meta model 110, a DDL (Data Definition Language) tuning meta model 115, a data generator meta model 120, a database server meta model 125, and a query set meta model 130. In some embodiments, a benchmark in accordance with data model 100 may include one or more of the of benchmark component types 105 and in some embodiments may include other varieties of benchmark component types not specifically depicted in FIG. 1 or explicitly disclosed herein. Conceptually, the benchmark component types will each comprise a meta model, whether specifically shown in FIG. 1 or explicitly disclosed herein, in accordance with data model 100 and other aspects herein.

In some embodiments, benchmark component type data definition 110 may provide abstract information regarding the schema definition of workload data for individual benchmarks such as, for example, TPC-H (Transaction Processing Performance Council defined TPC Benchmark™ H). In some embodiments, data definition 110 may describe aspects such as the tables, columns, data types, and constraints of the data model. The information specified by data definition 100 may be used in a variety of ways for various purposes. For example, the data definition information may be used to, among other possibilities, generate DDL statements for creating tables (with, for example, meta-data specific for each individual database server type); and to generate consistent data preserving constraints and relationships. Data definition 100 may specify or allow the choosing of, for example, which columns of a database structure are used for for the execution of the benchmark represented by data model 100.

In some embodiments, benchmark component type DDL tuning 115 may be provided to further define or tune the (basic) data model specified by benchmark component type data definition 110. DDL tuning 115 meta model may be used to achieve enhanced benchmark refinements. In some aspects, DDL tuning may conceptually be separated from data definition 110 in an effort to provide greater flexibility in benchmark design and execution. In some embodiments,“tuning” DDL as specified by DDL tuning meta model 115 may include aspects such as index creation, materialized views, and partitioning. In some aspects, the abstract modeling of basic data definitions by data definition meta model 110 and the tuning provided by DDL tuning meta model 115 by a system and method conforming to data model 100 may create both combined and incremental DDL statements at different states within a running execution of a benchmark.

In some embodiments, benchmark component type data generator 120 may be provided to populate a database instance with an experimental data set before the execution of an SQL statement (or other database operand) in the executing of a benchmark execution. In some embodiments, one or more different types of data generators may be supported. In some aspects, the different types of supported data generators may be combined.

In some embodiments, data generator 120 may define a predefined type of data generator that can generate data for common or standardized benchmarks (e.g., one or more of the “TPC” benchmarks) and support the parameters given in the common/standardized benchmark specification.

In some other embodiments, data generator 120 may define a generic user-defined data generator that comprises a built-in generator that uses information from data definition 110 and database server information (e.g., benchmark component type database server 125). In some embodiments, the generic user-defined data generator may define and specify such aspects as the size, value distribution, and correlation between the tables of a database. Also, referential integrity constraints and arbitrary join paths with a chosen selectivity may be defined by this type of data generator. In some aspects, these aspects defined by the data generator may be exposed as parameters.

In some embodiments, benchmark component type data generator 120 may define a custom data generator that establishes specific requirements that may be expressed in the benchmark service as custom classes or by calling an external tool. In some aspects, parameters associated with this type of data generator may be specified for integration into a benchmarking service provided based on data model 100.

In some embodiments, benchmark component type database server 125 may define the database(s) supported by the benchmarking data model 100. In some aspects, a benchmarking service herein may support a multitude or variety of different database servers. Accordingly, database server meta model 125 may operate to specify a variety of different database servers. In some embodiments, database server 125 may address three aspects of a database server. Aspects addressed by the database server meta model 125 may include (1) the capabilities of the supported database system(s), including data types, column types, DML (data manipulation language) expressions, etc. that may be used to tailor DDL and DML statements; (2) operational information regarding how to perform operations on the actual server instances (e.g., establishing a connection, executing a query, interpreting the results, and other aspects that may be relevant when running a benchmark); and (3) tunables that are not reachable via normal DDL statements (e.g., a “merge interval” of database instance or memory/disk settings of database system).

In some embodiments, benchmark component type query set 130 defines the set of queries to be executed in an execution of a benchmark conforming to data model 100. In some aspects, a benchmark execution may include DML statements in their textual form including, for example, standard SQL statements such as queries, insert, update, and delete operations, as well as stored procedures or scripts in different scripting languages (e.g., PL/SQL or T-SQL). In some aspects, each statement has a possibly empty set of parameters (including type information) for input and output values, allowing for parameterized queries and reusing the output of one query as an input for another. Depending on the query specifics, these parameters may be applied by text replacement or as invocation-time arguments.

In some embodiments, parameters may be defined or specified at the abstraction level of the meta models 105. That is, parameters may be defined when the benchmark component type(s) or artifact type(s) are defined. FIG. 1 shows a number of parameters (e.g., parameters 112, 114, 117, 119, 122, 124, 127, 129, 132, and 134) that have been defined at 107 with the plurality of benchmark component types 105 (e.g., meta models 110, 115, 120, 125, and 130). In the example of FIG. 1, the parameters 112, 114, 117, 119, 122, 124, 127, 129, 132, and 134 are shown as being bound to different ones of the benchmark component types 105. In some aspects, a parameter may be bound immediately to a benchmark component type or left unbound (and bound to, for example, any level of the data model, as will be explained in greater detail below).

In general, a benchmark in accordance with aspects herein may be viewed as a subset of a cross-product of the benchmark component or artifact types 105 and parameters 107 associated therewith. In light of the possibly large design space, benchmarks herein may be structured according to templates and measurements. As referred to herein, “templates” at varying levels of abstraction define the type of a benchmark. Examples of such templates include “a parameterized query on a server ” and a “several grouped generator runs” template types. As referred to herein, “measurements” are a grouping of artifacts along particular aspects that yield a particular result set such as, for example, a line in a graph for a query, scaled over the database size, etc. In some embodiments, the known set of artifacts, possible parameters, and templates may provide information to a user interface (e.g., GUI) to assist a user to intuitively design and run benchmarks in accordance with certain aspects herein.

Referring again to FIG. 1, data model 100 of a benchmark includes instances 135 of the meta models (i.e., the benchmark component types 105). In some regards, the instances (e.g., 135) of the benchmark component types 105 may be referred to herein as “artifacts”. In FIG. 1, an instance of each meta model 105 is illustrated. As shown, the data definition or schema 110 meta model is used to generate schema instance 140; the DDL tuning 115 meta model is used as a basis to generate DDL instance 145; the data generator 120 meta model is used to generate data generator instance 150; the database server 125 meta model is used to generate database server instance 155; and the query set 130 meta model is used to generate query set instance 160. It is noted that for a particular benchmark embodiment, fewer than all of the possible benchmark component types 105 and instances 135 of the benchmark component types 105 may be used to form the given benchmark. In some embodiments, one or more parameters defined at 107with the definition of the benchmark component types may be bound to an instance 135 of the benchmark component types. This aspect is illustrated by example parameter 142 that is bound to data definition instance 110 and parameter 162 that is bound to query set instance 160.

With continued reference to FIG. 1, a benchmark definition 165 may include a specified combination or subset of a cross-product of the benchmark component or artifact types 105 and the parameters (defined at 107) associated therewith. It is again noted that while all of the instances of the benchmark component types (i.e., meta models) 105 are depicted in FIG. 1, embodiments may exist where fewer than all of the possible instances 135 of the benchmark component types 105 may be used to form the given benchmark definition 165. In some embodiments, a template may specify the instances of the benchmark component types defining a given benchmark.

In some aspects, a benchmark may not consider individual queries in isolation, but instead considers queries that are combined at varying levels of complexity. Accordingly, a benchmark herein may include an execution order meta model 170 that provides mechanism(s) to express the (complex) interactions of the queries. For example, for workloads that consider state changes explicitly, an ordering of the query set may be given; and for workloads that combine multiple queries with different cost(s) or characteristics, a query mix may be specified. As illustrated in FIG. 1, parameters 167 and 169 are depicted as being bound to execution order 170 (e.g., a query parameter that is varied).

In some embodiments, a built-in model and driver may provide functionality to define “common” aspects such as the distribution of query types and/or their timing. In some embodiments, one or more custom query mix drivers may be included to manage query execution order specifications that are not expressible by standard query execution order settings.

A benchmark according to data model 100 may be executed to yield a set of measurements 175. Measurements 175 may be defined to yield a particular result set that conveys specified attributes, characteristics, and metrics. As illustrated in FIG. 1, parameters 172 and 174 are depicted as being bound to measurements 175.

In some embodiments, parameters associated with a benchmark (e.g., 112, 114, 117, 119, 122, 124, 127, 129, 132, 134, 142, 162, 167, 169, 172, and 174) conforming to data model 100 may be defined or specified in connection with execution order meta model 170 (e.g., parameters 167 and 169) and/or measurements meta model 175 (e.g., parameters 172 and 174).

In some embodiments, the entire model 100, including benchmark component or artifact types 105 and benchmark specifications 165, as well as the results 175 may be stored in a versioned database. The maintained versioned results 180 may be used to, for example, track how embodiments of the benchmark artifacts and results change for modifications of the artifacts have evolved and at which version certain interactions have occurred. This versioning aspect may provide insights into a benchmarking service since some artifacts may have variants thereof (e.g., custom queries for specific database servers if automatic tailoring from meta model data is not sufficient).

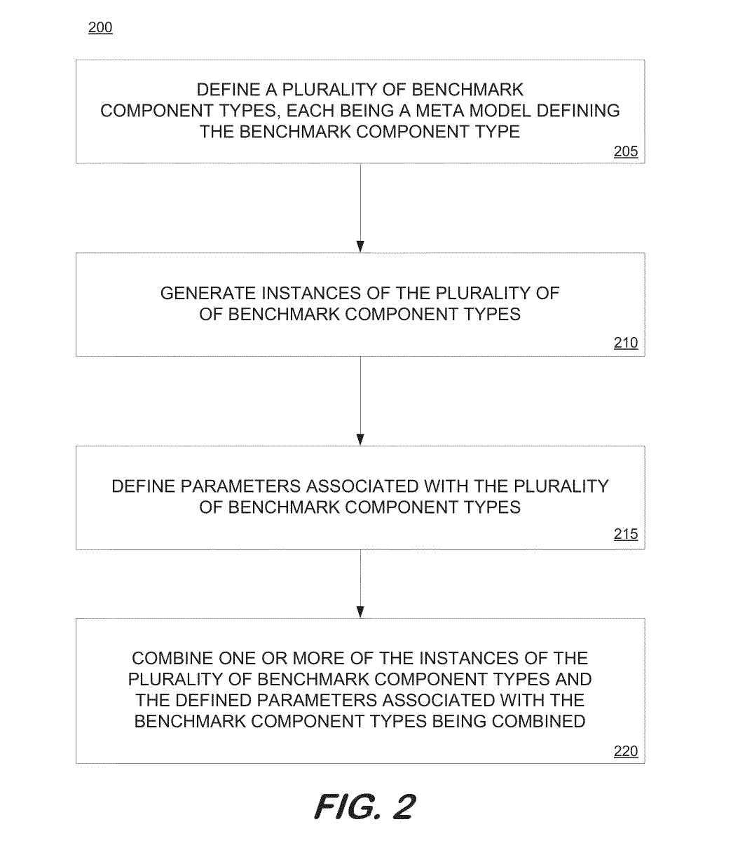

FIG. 2 is an illustrative flow diagram of a process 200, for some embodiments herein. In particular, process 200 may relate to an embodiment to generate a benchmark, implemented for example by a benchmarking service, that adheres to, conforms to, or utilizes, at least in part, a benchmark defined by a meta model such as data model 100. At operation 205, a plurality of benchmark component types may be defined. The plurality of benchmark component types (e.g., 105) may be defined by a user via a GUI of a processor-based computing device to specify the characteristics and attributes of the plurality of benchmark component types. As introduced above, each of the plurality of benchmark component types may be a meta model abstractly defining the benchmark component type.

At operation 210, instances of the plurality of benchmark component types are generated. The instances of the benchmark component types or artifacts conform (e.g., 135) to the benchmark component type meta models (e.g., 105).

At operation 215, parameters associated with the plurality of benchmark component types may be defined. In some embodiments, parameters associated with the benchmark component types may be specified (at least in part) in relationship with the defining of the plurality of types of benchmark components. In some embodiments, parameters associated with the benchmark component types may be specified (or further specified, at least in part) in relation to the generating of the instances of the plurality of types of benchmark components. That is, operation 215 may occur as a discrete operation and/or in combination with other operations of process 200.

Continuing with process 200, one or more of the instances of the plurality of benchmark component types and the defined parameters associated with the benchmark component types may be combined to form a benchmark at operation 220. The particular one or more instances of the plurality of benchmark component types combined at operation 220 (e.g., FIG. 1, data definition instance 140, data generator instance 150, database server instance 155, and query set instance 160) to form the benchmark may be selectively designated by a user via a GUI. In some embodiments, queries associated with the benchmark may be executed according to a specified execution order as defined by an execution order meta model (e.g., metal model 170 of FIG. 1) to yield desired measurement(s), as implemented by a benchmarking service.

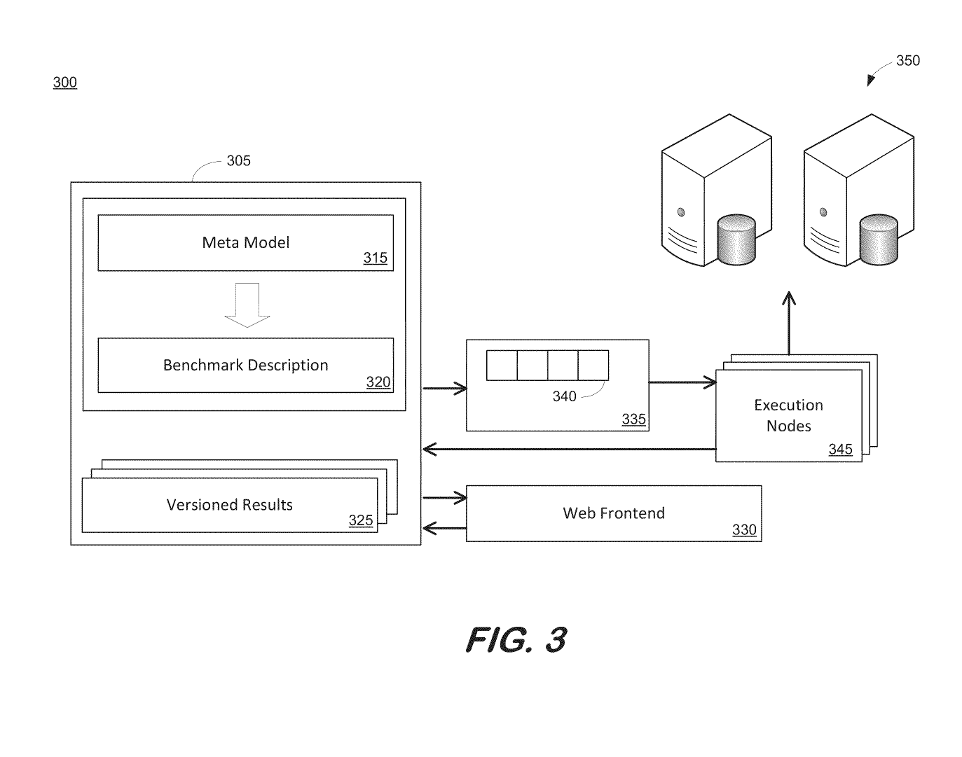

FIG. 3 is an illustrative block diagram of a system 300. In particular, FIG. 3 illustrates a distributed system architecture 300 of a benchmarking service, in accordance with some embodiments herein. System 300 includes a central service controller 305 that operates to track the meta model instances comprising the benchmarking service, including the actual meta model(s) 315 or artifacts comprising the benchmark description 320 and the versioned results 325 resulting from executing (e.g., experiment) benchmark Service controller 305 may interface or communicate with a web frontend 330. Web frontend 330 may provide and support a user interface such as a browser based GUI to facilitate receiving input from a user regarding specification of characteristics and attributes of the meta models herein, as well as specification of parameters and their values. Web frontend 300 may present information such as user input fields and benchmark results, as well as receive user provided input.

System 300 further includes a coordinator node or module 335. Coordinator node 335 may communicate with service controller 305 and operate to control a process of coordinating the running of benchmarking service jobs or tasks. In some embodiments, coordinator node 335 may include a job queue 340 (or an equivalent thereof) that contains a queue of benchmarks that are to be executed. Coordinator node 335 may also operate to distribute benchmarking jobs, as well as to detect node failures and timeouts, and other functions.

In some embodiments, the benchmarks may be executed or run on several execution nodes 345. In some embodiments, at least some of execution nodes 345 may run in parallel in order to, for example, simulate a multi-user workload or to efficiently speed up measurements. In some aspects, each execution node 345 may, in turn, distribute the actual database measurements over several instances of database servers 350.

In some aspects, a user may register database server(s) with different levels of access, including but not limited to, as a normal user via JDBC(Java Database Connectivity)/ODBC(Open Database Connectivity), as a database administrative user, or as a OS user. In some aspects, the more access a user grants to the service, the more precisely the execution flow can be controlled. An example use-case for system 300 may include a benchmark cluster in each department of a company or other organization.

In some embodiments, system 300 may be embodied as a distributed system to deliver a benchmarking service, including local and remote devices. In some embodiments, the benchmark or benchmarking service herein may be deployed as a service in the cloud.

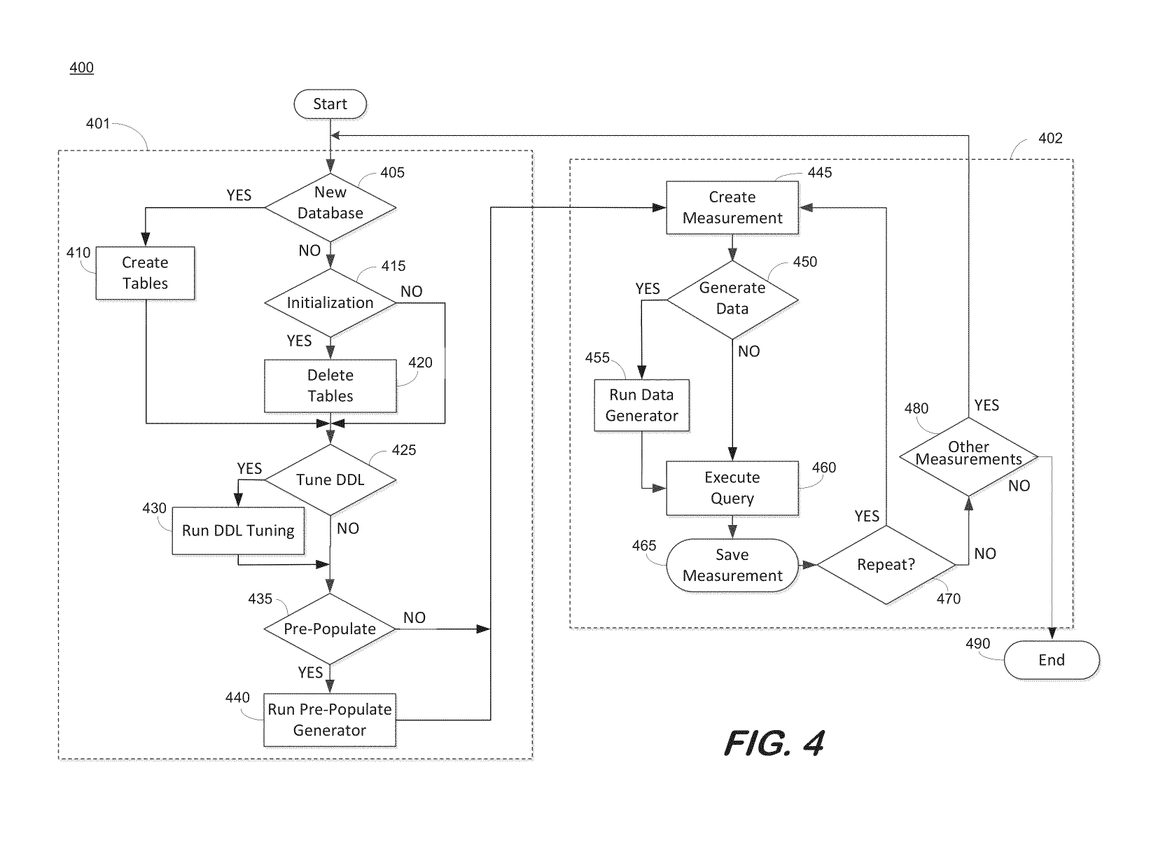

FIG. 4 is an illustrative flow diagram 400 of a process, in accordance with some embodiments herein. In particular, process 400 relates to an execution or running of a benchmark or benchmarking service in accordance with aspects herein.

In some embodiments, a benchmarking service herein may include a number of mechanisms to facilitate efficient operation. For example, a system herein may provide a user the opportunity to specify directly or implicitly (using a template) an execution flow or order. In another example, the benchmarking service may apply a number of optimizations, including, for example, a sequence of steps may be modified to reuse previous, resource costly stages (e.g., dataset creation or DB loading); and a data generator may utilize caching and pipelining, depending on a system setting, to reduce memory and/or CPU costs and execution time. In some aspects, a controller (e.g., coordinator 335) may distribute and parallelize steps to efficiently use the resources of the available nodes (e.g., execution nodes 345).

In some aspects, the correctness of the benchmarking results and precision of resource measurements may be deemed important. In some embodiments, systems and processes herein may take considered steps to ensure correctness and precision. For example, within a benchmarking execution, measurements may be performed on a “hot” database and repeated several times to achieve stable results. In this manner, a user may specify stable reference results against which the output values of queries may be compared. The defined and specified server(s), data schema, generator(s), and queries of a benchmarking data model herein may be combined to form a definition of a new benchmark.

FIG. 4 is an illustrative flow diagram of a process 400, in accordance with some embodiments and aspects herein. In particular, process 400 may relate to the running or executing of a database herein and generally includes an initialization stage 401 and a measurement stage 402. Regarding process 400, it may be assumed the benchmark has been defined. Defining of the benchmark may include, for example, registering new database servers registered with the system that will execute the benchmark. A new database schema related to the synthetic data used to, for example, micro-benchmark join queries, may be created. In a next step a user defined data generator for this schema may be defined and specified using a GUI. In some aspects, different types of distributions for each field of the tables (e.g., uniform distribution, Zipf distribution and sequences) may be specified in order to assess how the joins are processed on skewed data. The data generator may be defined to populate the database with values meeting the specified constraints and distribution(s).

Referring to FIG. 4, a determination is made whether to create a new database at 405. In the event a new database is created, process 400 continues to create the new data tables at 410 and then proceeds to 425. In the event a new database is not created at 405, process 400 continues to determine whether the existing database is to be initialized at 415. If the existing database is to be initialized, then the data in the existing tables is deleted at 420 and the flow proceeds to 425. If the existing database is not to be initialized at 415, then the flow proceeds to 425. At operation 425, a determination is made that considers whether to tune or modify the DDL as specified in the benchmarking specification. In the event that DDL tuning is specified or determined to occur at 425 (e.g., via optimization considerations) process 400 proceeds to run DDL tuning at operation 430 and advances to decision point 435. If DDL tuning is not called for at 425, then the flow proceeds to 435. At decision point 435, a determination is made whether to pre-populate the database instance(s). If yes, a pre-population data generator is invoked at operation 440 with continued flow to operation 445. If no, then the flow proceeds directly to operation 445.

The measurement stage 402 includes creating a measurement (e.g., benchmark components to include in the benchmark and specifying parameters) at operation 445. At operation 450, a determination is made whether to generate data using a data generator of the benchmark definition. In the event it is determined that the data is to be generated for the database instance(s) used by the executing benchmark, then the data generator is invoked at operation 455 and the process proceeds to execute the queries of the benchmark at operation 460. In the event it is determined that the data is not to be generated at operation 450, then process 400 proceeds directly to operation 460. The results of the benchmarking service (and versions thereof) may be saved at operation 465 (e.g., in a versioning data store). In some embodiments, a progress of the running benchmark's progress may be monitored using, for example, a web-interface (e.g., a GUI provided via web frontend 330).

In some embodiments, when the running of the benchmark is completed at operation 460 the results thereof are stored at operation 465.

In some aspects, the reported results may be used to examine the visualization of the measurement results. Based on the definition of the benchmark, it may be determined that some aspects of the benchmarking and/or data used therein may be adapted (e.g., adjust the data type and the selectivity of the join attributes) at operation 470. The same measurement may be repeated as determined at operation 470 by proceeding back to operation 445 (e.g., same query on different database servers). Additionally, operation 480 may determine whether any additional measurements (i.e., different combinations of the benchmark meta models) are to be run. If other measurements are desired, then the process returns to operation 405. Otherwise, process 400 may terminate at 490. In some embodiments, an e-mail with a link to a result page (or other type of message) may be sent to an entity upon completion of measurements at operation 480. Other reporting mechanisms may also be employed, including for example the creation of reports, dashboards, and other visualizations.

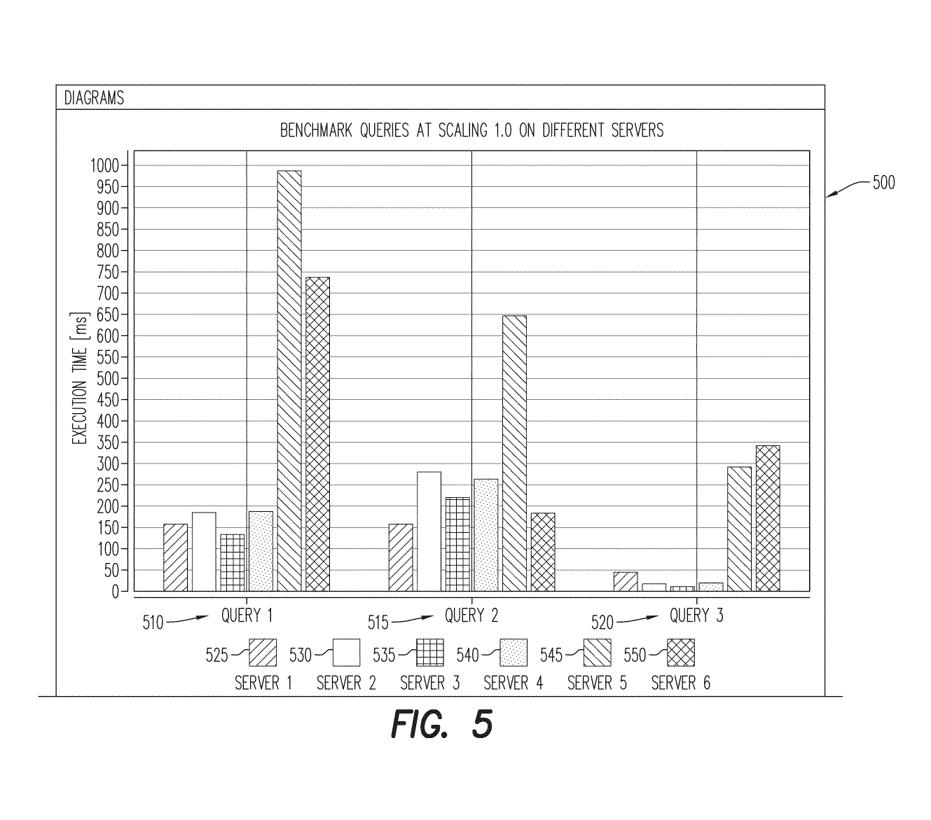

FIG. 5 is an illustrative depiction of a measurement result 500 that may be presented in a display panel of a GUI, in accordance with some aspects herein. As illustrated, measurement result 500 displays the performance results related to executing three queries (e.g., Query 1, 510; Query 2, 515; and Query 3, 520) on six different database servers (e.g., Server 1, 525; Server 2, 530; Server 3, 535; Server 4, 540; Server 5, 545; and Server 6, 550). In some aspects, a data visualization for a benchmarking service in accordance herewith may include other display configurations (not shown).

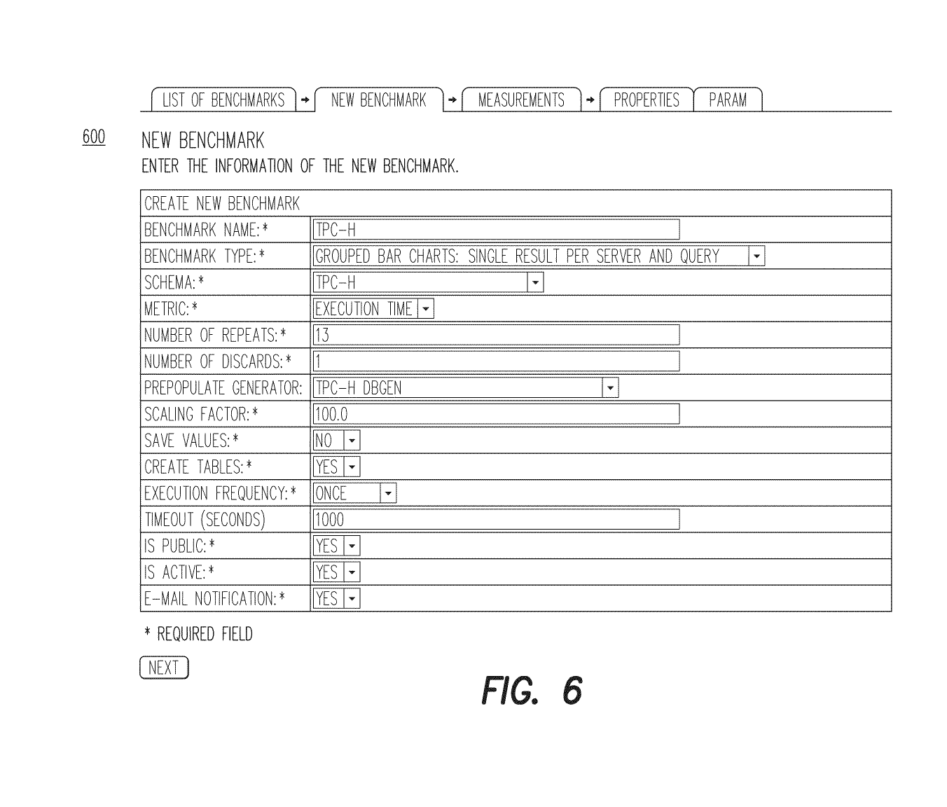

FIG. 6 is an illustrative depiction of a user interface 600 that may be presented in a display panel of a GUI, in accordance with some aspects herein. As illustrated, user interface 600 includes input fields for a variety of benchmark attributes. A user may provide input to a benchmarking service herein to indicate or otherwise specify values (e.g. a specific value or range of values) for the parameters presented in user interface 600. In some embodiments, a user may select a value from a drop-down (or other) type of menu or user interface element provided by the GUI. User interface 600 includes an example of some of the parameters that may be specified via a GUI in accordance with the present disclosure and is not intended to be an exhaustive listing thereof.

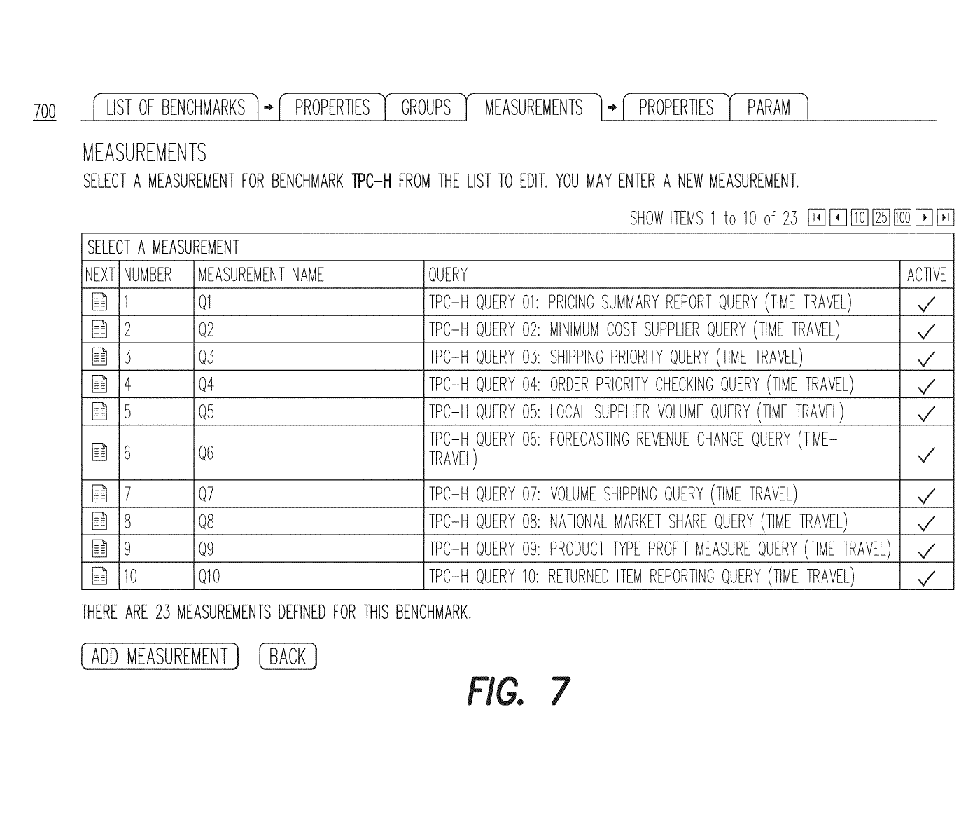

FIG. 7 is an illustrative depiction of a user interface 700 that may be presented in a display panel of a GUI, in accordance with some aspects herein. As illustrated, user interface 700 provides a mechanism for a user to specify one or more measurements to obtain in connection with the running of a benchmark or benchmarking service. As shown, a combination of measurements may be selected and specified. User interface 700 is an example of some of the measurement parameters that may be specified via a GUI in accordance with the present disclosure and is not intended to be an exhaustive listing thereof.

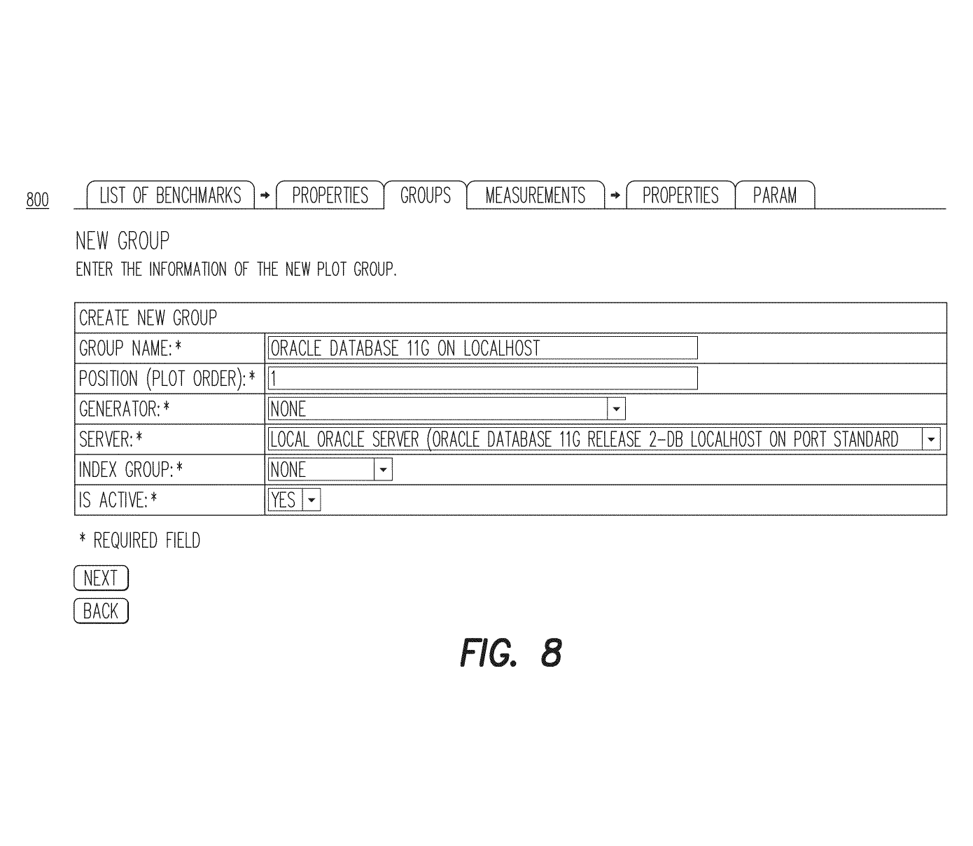

FIG. 8 is an illustrative depiction of a user interface 800 that may be presented in a display panel of a GUI, in accordance with some aspects herein. As illustrated, user interface 800 includes input fields for a user to define the parameters (i.e., set the values) associated with a plot group.

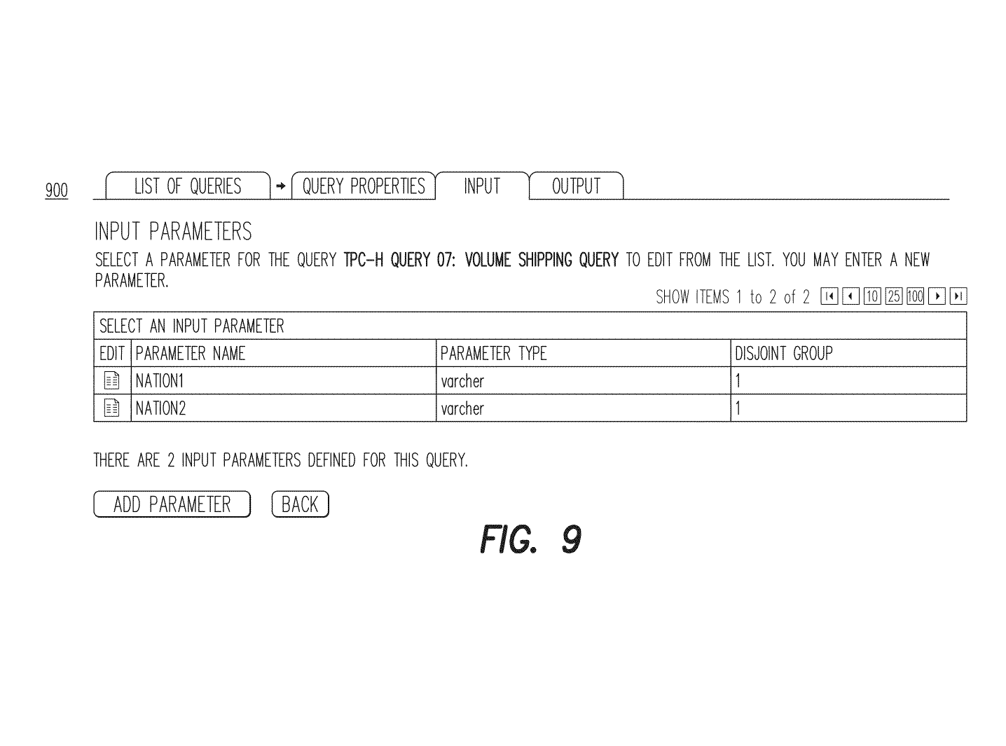

FIG. 9 is an illustrative depiction of a user interface 900 and may be presented in a display panel of a GUI, in accordance with some aspects herein. User interface 900 includes input fields for parameters related to a query and provides a mechanism for a user to select and edit query parameters, including the entry of new parameters. User interface 900 is a non-exhaustive example of some of the parameters that may be specified via a GUI in accordance with the present disclosure.

In accordance with some aspects herein, a new benchmark may be freshly created and defined by a benchmarking service of the present disclosure. In some aspects, it has been observed that a new benchmark may be created in about a few minutes as opposed to the several hours or more needed for a conventional manual implementation of a benchmark using a traditional scripting language. In accordance with aspects of the present disclosure, all reoccurring tasks such as plot generation, storing, archiving, and comparing results may be configured and handled automatically by the benchmarking service. In the manner disclosed herein, an expressive meta model that supports defining and reusing benchmark components (i.e., artifacts) and benchmark definitions including relevant associated properties (e.g., parameters) is provided, including an effective and user-friendly GUI.

All systems and processes discussed herein may be embodied in program code stored on one or more computer-readable media. Such media may include, for example, a floppy disk, a CD-ROM, a DVD-ROM, a Flash drive, magnetic tape, and solid state Random Access Memory (RAM) or Read Only Memory (ROM) storage units. Embodiments are therefore not limited to any specific combination of hardware and software.

Although embodiments have been described with respect to web browser displays, note that embodiments may be associated with other types of user interface displays. For example, a user interface may be associated with a portable device such as a smart phone or a tablet computing device (“tablet”), with a user interface element.

Embodiments have been described herein solely for the purpose of illustration. Persons skilled in the art will recognize from this description that embodiments are not limited to those described, but may be practiced with modifications and alterations limited only by the spirit and scope of the appended claims.

The embodiments described herein are solely for the purpose of illustration. Those in the art will recognize other embodiments which may be practiced with modifications and alterations.

What is claimed is:

1. A method comprising:
defining a plurality of benchmark component types, each of the benchmark component types being a meta model defining the benchmark component type;
generating instances of the plurality of benchmark component types;
defining parameters associated with the plurality of benchmark component types; and
combining one or more of the instances of the plurality of benchmark component types and the defined parameters associated with the benchmark component types being combined.

2. A method according to claim 1, further comprising binding at least one of the parameters with the instances of the plurality of benchmark component types.

3. The method of claim 1, wherein at least one of the defining of the parameters associated with the plurality of benchmark component types, and the combining of the one or more of the instances of the plurality of benchmark component types and the defined parameters associated therewith are specified by input received via a graphical user interface.

4. The method of claim 1, further comprising persisting the generated instances of the plurality of benchmark component types.

5. The method of claim 1, wherein the plurality of benchmark component types comprise at least one of a data definition meta model that abstractly describes data associated with a benchmark component, a data generator meta model that specifies data to generate to populate a database instance, a database server meta model that specifies at least capabilities and operational constraints of a database instance, and a query set meta model that specifies a set of queries to execute in an execution of a benchmark.

6. The method of claim 1, further comprising obtaining a measurement result by executing the combination of the one or more instances of the plurality of benchmark component types.

7. The method of claim 6, wherein queries performed in association with the executing of the combination of the one or more instances of the plurality of benchmark component types are performed in a prescribed execution order, the execution order conforming to an execution order meta model.

8. The method of claim 6, wherein the combination of the one or more instances of the plurality of benchmark component types, the defined parameters associated therewith, and the measurement result are collectively persisted in a versioned data store.

9. A computer-readable medium storing program code, the medium comprising program code executable by a computer to:
define a plurality of benchmark component types, each of the benchmark component types being a meta model defining the benchmark component type;
generate instances of the plurality of benchmark component types;
define parameters associated with the plurality of benchmark component types; and
combine one or more of the instances of the plurality of benchmark component types and the defined parameters associated with the benchmark component types being combined.

10. The medium according to claim 9, wherein at least one of the defining of the parameters associated with the plurality of benchmark component types, and the combining of the one or more of the instances of the plurality of benchmark component types and the defined parameters associated therewith are specified by input received via a graphical user interface.

11. The medium according to claim 9, further comprising program code to persist the generated instances of the plurality of benchmark component types.

12. The medium according to claim 9, wherein the plurality of benchmark component types comprise at least one of a data definition meta model that abstractly describes data associated with a benchmark component, a data generator meta model that specifies data to generate to populate a database instance, a database server meta model that specifies at least capabilities and operational constraints of a database instance, and a query set meta model that specifies a set of queries to execute in an execution of a benchmark.

13. The medium according to claim 9, further comprising program code to obtain a measurement result by executing the combination of the one or more instances of the plurality of benchmark component types and the defined parameters associated therewith.

14. The medium according to claim 13, wherein queries performed in association with the executing of the combination of the one or more instances of the plurality of benchmark component types are performed in a prescribed execution order, the execution order conforming to an execution order meta model.

15. The medium according to claim 13, wherein the combination of the one or more instances of the plurality of benchmark component types, the defined parameters associated therewith, and the measurement result are collectively persisted in a versioned data store.

16. A system comprising:
a controller to track instances of a plurality of benchmark component types, wherein the plurality of benchmark component types are each a meta model defining the benchmark component type; parameters associated with the plurality of benchmark component types; and a specified combination of one or more instances of the plurality of benchmark component types and the defined parameters associated therewith that define a computer executable benchmark;
at least one execution node to run an execution of the benchmark; and
at least one instance of a database supporting the execution of the benchmark.

17. The system according to claim 16, further comprising a coordinator module to distribute execution tasks to the at least one execution node.

18. The system according to claim 16, further comprising a graphical user interface to provide a mechanism to selectively specify at least one of: values to associate with the parameters associated with the plurality of benchmark component type s and the one or more of the instances of the plurality of benchmark component type s to combine.

19. The system of claim 16, further comprising a data facility to store versions of the combination of the one or more instances of the plurality of benchmark component types, the defined parameters associated therewith, and a measurement resulting from an execution of the benchmark.

20. The system according to claim 16, wherein the plurality of benchmark component types comprise at least one of a data definition meta model that abstractly describes data associated with a benchmark component type, a data generator meta model that specifies data to generate to populate a database instance, a database server meta model that specifies at least capabilities and operational constraints of a database instance, and a query set meta model that specifies a set of queries to execute in an execution of a benchmark.
